(19) United States
(12) Patent Application Publication
(10) Pub. No.: US 2026/0334718 A1
(43) Pub. Date: Oct. 29, 2026

(54) METHOD FOR OPERATING A COFFEE MACHINE

(71) Applicant: BSH Hausgeräte GmbH, München (DE)

(72) Inventors: Thomas SCHREINER, Aschau am Inn (DE); Matthias LOSBICHLER, Taufkirchen (DE); Thomas REICHEL, Traunstein (DE)

(21) Appl. No.: 19/099,146

(22) PCT Filed: Jul. 4, 2023
(86) PCT No.: PCT/EP2023/068404

§ 371 Date: Jan. 28, 2025

(30) Foreign Application Priority Data
Jul. 28, 2022 (DE) 10 2022 207 810.1

(51) Int. Cl. A47J 31/52; A47J 31/42

(52) U.S. Cl. CPC A47J 31/521; A47J 31/42

(57) ABSTRACT

A method for operating a coffee machine for preparing a coffee beverage, includes automatically setting the grind size of coffee beans. A selection of a desired coffee beverage is first made by a user. In response thereto, a facility then determines a grind size corresponding to the selected coffee beverage and transmits the same to a grinder which then grinds the coffee beans to the transmitted grind size. In this manner, a meaningful increase in comfort can be achieved for the user. A coffee machine for preparing a coffee beverage and a computer program product for carrying out the method, are also provided.

The present invention relates to a method for operating a coffee machine for preparing a coffee beverage. The invention relates moreover to a coffee machine with a facility for carrying out such a method and a corresponding computer program product.

EP 2 279 683 A1 discloses a method for the user-controlled production of a food product, in particular a liquid food product, in which gustatorily, olfactorily and/or tactilely perceptible flavoring substances are extracted from a precursor product by an automatic machine and transferred to the food product. The extraction of the flavoring substances is influenced by the user-controlled setting of at least two technical parameters of the automatic machine in order to produce a desired quality of the food product. The technical parameters required for this are set by a user-controlled electronic translation circuit, which controls the technical parameters during production based on user-selected values of the human sensory attributes and on the basis of a predetermined sensory profile of the precursor product. This is designed to allow a desired taste, aroma or texture of the food product to be set more precisely.

WO 2022/003743 A1 discloses an automatic coffee machine for preparing coffee beverages by infusing ground coffee, comprising a control and monitoring facility configured to adjust and select at least one operating parameter of a pre-infusion step: A flow rate of the pre-infusion water, an amount of the pre-infusion water and a duration of the pause at the end of the pre-infusion step and this as a function of a granulometry of the ground coffee.

In the case of coffee machines, different settings of the grind size can be used in a known manner for different coffee beverages. Beverages with a small volume, such as an espresso, can be brewed with more finely ground coffee, i.e. a finer grind size distribution, since in this case a contact time between the brewing water and the ground coffee is short in order to release the desired components from the ground coffee. Coffee beverages that are larger in volume, such as a caffe crema, are usually brewed with more coarsely ground coffee, i.e. ground coffee with a coarser grind size distribution, since otherwise the contact time between the brewing water and the ground coffee may be too long, resulting in the release of undesirable bitter substances that have a negative effect on the taste.

Some coffee machines have an appropriate facility for setting the grind size, which allows the user to set the grind size manually. However, if the user lacks the detailed knowledge required in this respect, such a facility for adjusting the grind size of the ground coffee is of no use to the user or even leads to the wrong grind size being selected for the respective desired coffee beverage, for example a coarse grind size setting for an espresso.

The present invention therefore deals with the problem of providing a method by means of which, in particular, comfortable coffee preparation can be significantly increased, even for users with little or no coffee preparation knowledge.

This object is achieved by means of the subject matter of the independent claim 1. Advantageous embodiments are the subject of the dependent claims.

The present invention is based on the general idea of automatically selecting a grind size of ground coffee for the preparation of a coffee beverage and thereby also enabling users with no or only little coffee knowledge to easily prepare tasty coffee beverages. In the method according to the invention for operating a coffee machine, a desired coffee beverage is selected by a user during the automated setting of the grind size, whereupon a facility determines a grind size associated with the selected coffee beverage and transmits it to a grinder, which then grinds the coffee with the transmitted grind size, i.e. with a predefined fineness. The method according to the invention can be made available to the user, for example, by means of a so-called flavor boost function which, when activated by the user, automatically selects the grind size in accordance with the method according to the invention and thus optimally adapts it to the desired coffee beverage. This not only makes it extremely comfortable to operate a coffee machine, but it is also possible to improve the taste of the coffee and therefore increase customer satisfaction. A particular advantage of this is that users can achieve an optimum grind size for their desired coffee beverage even without detailed coffee knowledge. Of course, a coffee machine carrying out this method according to the invention can offer the flavor boost function only as an option, so that the user can also additionally or alternatively set the grind size manually, in order to enable experienced users with at least a little barista knowledge in particular to prepare their coffee beverages individually.

In an advantageous further development of the method according to the invention, the facility takes the grind size associated with the selected coffee beverage from a stored characteristic diagram. In such a characteristic diagram, for example, each coffee beverage that can be prepared by a coffee machine, such as an espresso or a caffé crema, can be assigned a specific grind size, so that by selecting the desired coffee beverage and activating the method according to the invention, the desired coffee beverage is produced with the optimum grind size for it. Other parameters for the desired coffee beverage, such as the amount of coffee, amount of water, brewing time, etc., can of course also be stored in this characteristic diagram. The grind size associated with the respective selected coffee beverage can be determined, for example, via corresponding analyses and stored in the characteristic diagram.

In an advantageous development of the method according to the invention, the facility determines the grind size associated with the selected coffee beverage on the basis of an amount of beverage to be dispensed. This is due to the fact that, by way of example, a coarser grind size is selected for large-volume coffee beverages, such as a caffe crema, in which there is a longer contact time between the brewing water and the ground coffee, in order to avoid an undesired release of bitter substances from the ground coffee. For small-volume coffee beverages, such as an espresso, the grind size can be set correspondingly finer, i.e. the coffee is ground correspondingly finer, since in this case the contact time between the brewing water and the ground coffee is shorter and therefore the surface area of the ground coffee should be as large as possible so that the espresso can absorb as many flavors as possible.

In a particularly preferred embodiment of the method according to the invention, the facility determines the grind size associated with the selected coffee beverage on the basis of a brewing temperature associated with the selected coffee beverage. It is known that an espresso usually requires a brewing temperature of between 92 and 96 °C, while other types of coffee beverages, such as a caffé crema, require a lower brewing temperature. If the brewing water is very hot, the resulting coffee often tastes bitter, since the higher brewing temperature releases many bitter substances from the ground coffee. If the brewing temperature is too low, the coffee beverage produced tastes slightly sour or watered down, since in this case not enough flavoring substances are released from the ground coffee, but rather acids which are the first to be extracted from the ground coffee during the extraction process are released. Of course, the brewing temperature usually also correlates with the selected coffee beverage or the respective amount of beverage.

In a further advantageous embodiment of the method according to the invention, the facility determines the grind size associated with the selected coffee beverage on the basis of a brewing time associated with the selected coffee beverage. Again, a long brewing time requires a coarser grind size, since otherwise too many bitter substances are released from the ground coffee and can give the coffee beverage a bitter taste. If, on the other hand, the brewing time is significantly shorter, such as for an espresso, the method according to the invention selects a finer grind size and thus a higher grinding fineness of the coffee to be ground in order to provide the brewing water with a sufficiently large surface area to extract the flavoring substances required for an optimum coffee taste.

Advantageously, the facility determines the grind size associated with the selected coffee beverage on the basis of an amount of ground coffee associated with the selected coffee beverage. Since a caffe crema is usually made with a larger amount of ground coffee compared to an espresso, the grind size can also be adjusted depending on the amount of ground coffee. In specific terms, this means that a higher grinding fineness is selected for a smaller amount of ground coffee than for a larger amount of ground coffee.

In a further advantageous embodiment of the method according to the invention, the facility determines the grind size of the ground coffee associated with the selected coffee beverage on the basis of a brewing pause associated with the selected coffee beverage. Such a brewing pause takes place between a pre-brewing phase and a main brewing phase, wherein such a brewing pause means an extension of a contact time of the brewing water in contact with the ground coffee. The brewing pause, in turn, can depend on the respective desired coffee beverage.

In a particularly preferred embodiment, the grind size is set manually by the user in a comfort mode, in particular fine, medium or coarse. If the user then activates the flavor boost function, the facility increases the grind size for all coffee beverages containing an espresso, for example, compared to the manually set grind size. This allows the user to set the grind size themselves in the comfort mode and supports them with the flavor boost function.

The present invention is further based on the general idea of providing an automatic coffee machine for preparing a coffee beverage, comprising an input facility, a grinder and a facility adapted to carry out the method according to the preceding paragraphs. Using a coffee machine of this type, even inexperienced users can produce a wide variety of tasty coffee beverages, such as espressos or caffe crema, with comparative ease, since the optimum grind size for the respective coffee beverage is automatically preset by activating the facility or the flavor boost function. In addition or alternatively, it is of course also possible with such automatic coffee machines according to the invention for users to select a grind size themselves via a corresponding input facility, for example a display, for example fine, medium or coarse, in particular if the respective user is familiar with the preparation of coffee beverages and therefore has a certain amount of coffee knowledge. With the coffee machine according to the invention, it is therefore possible for all users, regardless of whether they have special coffee knowledge or not, to produce coffee beverages with optimum taste.

Further important features and advantages of the invention can be seen from the subordinate claims, from the drawing and from the associated description of the figures with reference to the drawing.

In particular, the features that are mentioned above and are to be explained below are not only usable in the respective stated combination but can also be used in other combinations or on a stand-alone basis without departing from the scope of the present invention. The components that are mentioned above and are still to be mentioned below of a superordinate unit, such as a facility, an apparatus or an arrangement, which are designated separately, can form separate parts or components of this unit or can be integral areas or sections of this unit, even if this is shown differently in the drawings.

An exemplary embodiment of the invention is illustrated in the drawing and explained in detail in the following description.

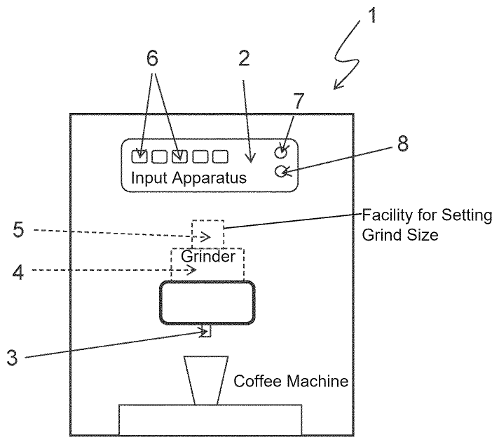

The single FIG. 1 shows a coffee machine according to the invention.

As shown in FIG. 1, a coffee machine 1 according to the invention has an input apparatus 2 via which a user can select individual coffee beverages. These are then produced inside the coffee machine 1 and dispensed via a beverage outlet 3. In addition, a grinder 4 and a facility 5, with which a grind size of the grinder 4 can be adjusted, are arranged within the coffee machine 1.

The coffee machine 1 according to the invention is designed to carry out a method according to the invention, in which a grind size of coffee beans can be set automatically. In the method according to the invention, the user first selects a desired coffee beverage, for example an espresso or a caffe crema, via the input apparatus 2. For example, different touch fields 6 can be provided on the input apparatus 2 for this purpose, wherein the input apparatus 2 can generally be designed as a touch screen. Alternatively, push-buttons are of course also conceivable.

Once the user has selected the desired coffee beverage via one of the touch fields 6, they can decide whether they want to select a grind size themselves using a comfort button 7 or leave the setting of the grind size to the facility 5 via a flavor boost button 8. If the user presses the flavor boost button 8 after selecting the desired coffee beverage via the respective touch field 6, the grind size is automatically set by means of the facility 5 depending on the selected coffee beverage.

The option to select the flavor boost function can also be generally available in the settings menu for all beverages. It is possible that the function can only be activated for espresso beverages and/or for larger coffee beverages.

The user can also initially set the grind size themselves by pressing the comfort button 7, in particular fine, medium or coarse. If the user then presses the flavor boost button 8, the facility 5 can increase the grind size for all coffee beverages containing an espresso, for example, compared to the manually set grind size. This can support the user.

This offers the great advantage that even users without detailed coffee knowledge can be offered an optimum taste of the desired coffee beverage, since the grind fineness, i.e. the grind size, of the coffee used to produce the desired coffee beverage is automatically set via the flavor boost button 8. In particular, this can reliably prevent too fine a grind size, for example for a caffe crema, or too coarse a grind size, for example for an espresso.

The facility 5 can take the grind size associated with the selected coffee beverage from a stored characteristic diagram, wherein it is additionally or alternatively also conceivable that the facility 5 determines the grind size associated with the selected coffee beverage on the basis of an amount of beverage to be dispensed. If, for example, the amount of beverage to be dispensed is less than 100 ml, the facility 5 assumes that it is an espresso, for example, for which the grind size must be set much finer than for a larger-volume coffee beverage, such as a caffe crema.

Further additionally or alternatively, the facility 5 can also determine the grind size associated with the selected coffee beverage on the basis of a brewing temperature associated with the selected coffee beverage, since such a brewing temperature is usually also dependent on the selected coffee beverage.

In a particularly advantageous embodiment, the facility 5 can determine the grind size associated with the selected coffee beverage on the basis of a brewing pause, brewing time and/or the amount of ground coffee associated with the selected coffee beverage. These parameters also determine the taste of the coffee beverage to be produced, since an espresso, for example, has a significantly shorter brewing time than a caffe crema and therefore requires a greater grind size to provide the larger surface area required for the short brewing time in order to release a sufficient amount of flavoring substances from the coffee and thus produce a tasty coffee beverage.

Alternatively, it is of course also possible with the coffee machine 1 according to the invention for the respective user only to set the grind size themselves by pressing the comfort button 7, so that the coffee machine 1 according to the invention offers all users, i.e. both those with little or no coffee knowledge and those with coffee knowledge, a significant increase in comfort.

However, users with little or no coffee knowledge can benefit in particular from the method according to the invention, since they can achieve an optimum grind size for the desired coffee beverage in each case using the flavor boost button 8 according to the invention.

### REFERENCE CHARACTERS

1 Coffee machine
2 Input apparatus
3 Beverage outlet
4 Grinder
5 Facility
6 Touch field
7 Comfort button
8 Flavor boost button

1-11. (canceled)

12. A method for operating a coffee machine for preparing a coffee beverage by automatically setting a grind size of coffee beans, the method comprising:
selecting a desired coffee beverage by a user when automatically setting the grind size;
using a facility to determine the grind size associated with the selected coffee beverage;
transmitting the grind size to a grinder; and
then using the grinder to grind the coffee beans with the transmitted grind size.

13. The method according to claim 12, which further comprises using the facility to take the grind size associated with the selected coffee beverage from a stored characteristic diagram.

14. The method according to claim 12, which further comprises using the facility to determine the grind size associated with the selected coffee beverage based on an amount of beverage to be dispensed.

15. The method according to claim 12, which further comprises using the facility to determine the grind size associated with the selected coffee beverage based on a brewing temperature associated with the selected coffee beverage.

16. The method according to claim 12, which further comprises using the facility to determine the grind size associated with the selected coffee beverage based on a brewing time associated with the selected coffee beverage.

17. The method according to claim 12, which further comprises:
using the facility to determine the grind size associated with the selected coffee beverage based on an amount of ground coffee associated with the selected coffee beverage, or
using the facility to determine the grind size associated with the selected coffee beverage based on a brewing pause associated with the selected coffee beverage.

18. The method according to claim 12, which further comprises:
manually setting the grind size in a comfort mode; and
using the facility to refine the grind size for all coffee beverages containing an espresso compared to the manually set grind size when a flavor boost function is activated.

19. A coffee machine for preparing a coffee beverage, the coffee machine comprising:
an input apparatus;
a beverage outlet;
the grinder; and
the facility configured to carry out the method according to claim 12.

20. The coffee machine according to claim 19, wherein:
the input apparatus has a comfort button and a flavor boost button;
the comfort button is configured to manually set the grind size; and at least one of:
the flavor boost button is configured to activate the method, or
the facility is configured to increase the grind size for all coffee beverages containing an espresso in comparison to the manually set grind size.

21. The coffee machine according to claim 20, wherein the input apparatus is configured as at least one of:
a touch screen with touch fields for selecting the coffee beverage, or
a touch screen with the comfort button and the flavor boost button.

22. A non-transitory computer program product, comprising instructions that carry out the method according to claim 12 in a coffee machine including an input apparatus, a beverage outlet, the grinder, and the facility.
